(19) United States
(12) Patent Application Publication
(10) Pub. No.: US 2017/0344327 A1
(43) Pub. Date: Nov. 30, 2017

(54) Communication Visualisation

(71) Applicant: Microsoft Technology Licensing, LLC, Redmond, WA (US)

(72) Inventors: Jason Thomas Faulkner, Seattle, WA (US); Casey James Baker, Seattle, WA (US)

(73) Assignee: Microsoft Technology Licensing, LLC, Redmond, WA (US)

(21) Appl. No.: 15/167,237

(22) Filed: May 27, 2016

(51) Int. Cl. G06F 3/14; H04L 29/08; H04L 29/06; G06F 3/16; G06T 11/00

(52) U.S. Cl. CPC G06F 3/14; H04L 67/22; H04L 65/4007; G06T 11/001; G06F 3/16

(57) ABSTRACT

A communication method comprising receiving input from a participant of a communication event and obtaining an activity metric of said at least one participant in a communication event based on received inputs. A visual theme is varied dynamically in dependence upon the activity metric, to provide a visual indication of the activity of said participant.

### TECHNICAL FIELD

The present disclosure relates to communication and collaboration over a network, and to enhancing communication over a network.

### BACKGROUND

Communication and collaboration are key aspects in people's lives, both socially and in business. Communication and collaboration tools have been developed with the aim of connecting people to share experiences. In many or most cases, the aim of these tools is to provide, over a network, an experience which mirrors real life interaction between individuals and groups of people. Interaction is typically provided by audio and/or visual elements.

Such tools include instant messaging, voice calls, video calls, group chat, shared desktop etc. Such tools can perform capture, manipulation, transmission and reproduction of audio and visual elements, and use various combinations of such elements in an attempt to provide a communication or collaboration environment which provides an intuitive and immersive user experience.

A user can access such tools at a user terminal which may be provided by a laptop or desktop computer, mobile phone, tablet, games console or system or other dedicated device for example. Such user terminal can be linked in a variety of possible network architectures, such as peer to peer architectures or client-server architectures or a hybrid, such as a centrally managed peer to peer architecture.

### SUMMARY

Creating a shared experience for multiple users is difficult to provide in a natural intuitive way. In real life interaction between people and groups of people, many small visual cues are provided and used, and a large visual area being monitored for such clues with direction or focus of attention being rapidly changed subconsciously. It would be desirable to create an intuitive and natural communication and collaboration environment over a network.

According to a first aspect there is provided a communication method comprising: receiving input from a participant of a communication event; causing a display to render at least one grid section associated with at least one participant of a communication event, said grid section including at least one identifier of said participant, and a background area; associating a visual theme with said background area of said grid section; obtaining an activity metric of said at least one participant in a communication event based on received inputs of said participant, said activity metric having a range of variability; and causing the display to vary said visual theme dynamically in dependence upon the activity metric, to provide a visual indication of the activity of said participant.

A second, related aspect provides a communication method comprising receiving information of a shared user event having one or more participants; causing a display to render at least one event object representing said shared event, said event object having a foreground relating to the content and/or participants of the shared experience, and a background; associating a visual theme with the background of said object; obtaining an activity metric of said one or more participants of said shared event, said activity metric having a range of variability; causing the display to vary said visual theme dynamically in dependence upon the activity metric, to provide a visual indication of the activity of said shared event

In this way, it becomes easier for a user to follow a networked collaboration or communication event. The variation of the visual theme directs the attention of a user, effectively at a subconscious level to the most relevant or active participant or participants, as would happen in a face to face, or real life meeting or meetings. It is also easier for a user to understand who is speaking, or likely to be speaking next at any given instance, and the relative significance of participants over a given time period.

Where a multi participant event is represented by a single visualisation, a level of activity of the whole event is provided, and a user can quickly and easily gauge whether an event is busy or quiet for example. A relative assessment of the importance of two events for example can be quickly made, as can a decision as to whether or not to join an event.

This makes it easier to follow the direction of a call or other collaboration event more intuitively.

In embodiments, variation of the visual theme can be performed over a range of values or gradations, to provide a substantially continuous or semi continuous range of variation. This distinguishes over a simple binary on/off state, and can provide intermediate states in between. In embodiments the activity metric can similarly take a range of values or gradations, to provide a substantially continuous or semi continuous range of variability. Thus intermediate states between binary active/not active states can be provided. In such embodiments, the variation of the visual theme can be performed proportionally to the level of the activity metric, on a continuous or semi continuous scale, representing intermediate states between binary extremes.

Such variability or gradation allows a visual representation of relative states of objects and/or participants in intermediate, or semi-active states. Thus an indication or whether an object or participant is growing or decreasing in relevance can be made, or a comparison between two objects or participants in semi-active states can be made. An object or participant may also remain in an intermediate state for a period of time and this can be reflected more accurately. This provides an improved and more intuitive representation of multiple participants and objects.

In embodiments, the visual indication is provided with a delay. In embodiments, the activity metric is representative of activity over a period of time. In this way the visual indication offers a smoothed or longer term indication not of instant activity, but of activity over a defined period, which may vary according to the application. A period of approximately 2, 3, five or ten or more seconds may be suitable in examples. This effectively filters out sudden spikes or transitions in activity, and reflects longer term patterns of activity. In addition, some users may experience a delay or latency of a networked event, and such embodiments mitigate such latency to an extent.

In an example the activity metric is a moving average of instantaneous activity values, and may be a weighted moving average, for example to bias the average in favour of more recent activity. Linear weighting or exponential weighting may be used in examples. The activity metric can preferably take a range of values to provide a substantially continuous scale of activity.

The activity metric can, in embodiments, be based on or be representative of any type of detectable activity or input of a participant or participants of an event which it is desired to represent. The activity metric can be based on voice or audio input, movement or video input, a text or symbol or other control input of a participant of an event for example.

Different types of inputs can be combined in embodiments to provide an activity metric, and different weightings can be assigned if desired to place more or less importance on certain types of input. If different inputs or types of inputs are considered in combination, such inputs may be combined before any temporal averaging or filtering, or temporal averaging or filtering can be applied separately to different inputs. In this way, the duration or time period over which each input is considered or averaged can be tailed, and may vary from input to input.

Where the activity metric is representative of more than one participant, the inputs of participants can be combined. Thus in a collaboration event, such as a shared content activity input, the combination of participants inputs can be combined into a single metric. Furthermore, the number of people present or represented can be used as, or represented by a metric.

The participant state of one or more participants can be used to provide an activity metric in embodiments. For example, the state of leaving or joining an event, or of being an active or passive participant.

The visual theme is a colour or hue in embodiments, and varying said visual theme includes varying the lightness or shade of said colour in dependence upon the activity metric. The visual theme can also be a pattern, and varying said visual theme includes varying one or more of the visual weight or other visual configuration of the pattern, the colour or lightness of the pattern, or movement of the pattern. In embodiments the visual theme is at least one of an image, a graphic, a logo, a video or an animation. The duration of display of an object in a visual theme, or sequence of a moving visual theme may also be varied according to the activity metric. The visual theme may be an image, a graphic, a logo, a video or an animation in embodiments.

The visual theme, and the variation of the visual theme advantageously directs the attention of a user or viewer. Thus variation to represent greater activity is represented by changes to patterns, movements, colours or configurations which are more visually arresting or draw greater attention in embodiments. Typically, brighter or lighter colours draw greater attention, and more or more rapid movement draws greater attention for example.

The visual theme can be varied over a range of values or magnitudes or intensities in examples. Where variation is in the lightness or shade of a colour for example, a scale of multiple different values of lightness or shade are available, to represent a sliding/continuous scale of activity. Similarly, a range of intermediate values for other types of variation for other visual themes, such as visual weight, configuration, colour, and movement are preferably provided. This allows a variable range of activity metrics to be represented more accurately and intuitively.

In embodiments a shared user event or communication event may be a multi user peer to peer real time data sharing event. Such an event is preferably shared by two or more or three of more participants. A shared user event may comprise a voice call, video call, group chat, shared desktop, a presentation, live document collaboration, or a broadcast in embodiments.

According to a further aspect, there is provided a communication method comprising receiving input from a participant of a communication event; causing a display to render at least one identifier of a participant of a communication event; obtaining an activity metric of said at least one participant in a communication event based on received inputs of said participant; and causing the display to render first and second visual indicators of activity based on said activity metric, said first and second visual indicators being associated with the respective identifier of the participant, and providing a visual representation of the activity of said participant over first and second different timescales respectively.

In embodiments, the first visual indicator is a substantially instantaneous representation of activity, and in embodiments the second visual indicator is a representation of activity over a period of time. The first and second visual indicators may advantageously be displayed substantially simultaneously.

According to a yet further aspect there is provided a non-transitory computer readable medium or computer program product comprising computer readable instructions which when run on a computer including a display, case that computer to perform a method substantially as described herein.

The invention extends to methods, apparatus and/or use substantially as herein described with reference to the accompanying drawings.

Any feature in one aspect of the invention may be applied to other aspects of the invention, in any appropriate combination. In particular, features of method aspects may be applied to apparatus aspects, and vice versa.

Furthermore, features implemented in hardware may generally be implemented in software, and vice versa. Any reference to software and hardware features herein should be construed accordingly.

### BRIEF DESCRIPTION OF THE DRAWINGS

Preferred features of the present invention will now be described, purely by way of example, with reference to the accompanying drawings, in which:

FIG. 1 illustrates schematically an example communications system;

FIG. 2 is a functional schematic of a user terminal;

FIG. 3 shows a display for a communication and collaboration environment;

FIG. 4 shows a display for a communication visualisation;

FIG. 5 is a graph showing a conceptualised activity metric;

FIGS. 6 and 7 show background rendering of a communication visualisation display

FIGS. 8a, 8b, and 8c illustrate possible configurations of a communication visualisation display

FIG. 9 shows a display object for representing a multi user event

FIG. 10 shows possible display positions of a display object;

FIG. 11 shows an example of a communication visualisation display.

### DETAILED DESCRIPTION OF EMBODIMENTS

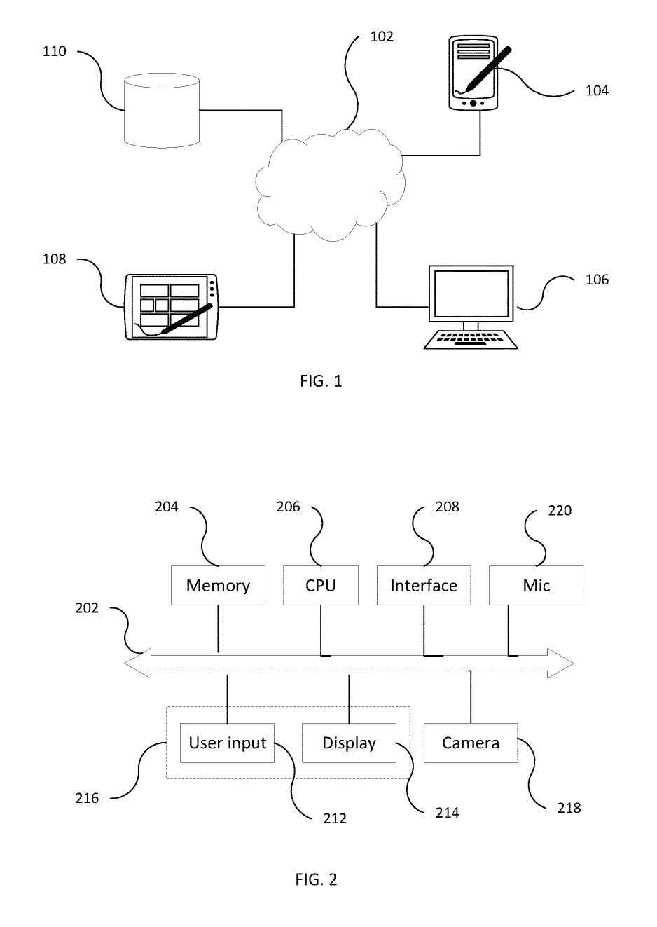

FIG. 1 illustrates an example of a communication system including example terminals and devices. A network 102 such as the internet or a mobile cellular network enables communication and data exchange between devices 104-110 which are connected to the network via wired or wireless connection. A wide variety of device types are possible, including a smartphone 104, a laptop or desktop computer 106, a tablet device 108 and a server 110. The server may in some cases act as a network manager device, controlling communication and data exchange between other devices on the network, however network management is not always necessary, such as for some peer to peer protocols.

A functional schematic of an example user terminal suitable for use in the communication system of FIG. 1 for example, is shown in FIG. 2.

A bus 202 connects components including a non-volatile memory 204, and a processor such as CPU 206. The bus 202 is also in communication with a network interface 208, which can provide outputs and receive inputs from an external network such as a mobile cellular network or the internet for example, suitable for communicating with other user terminals. Also connected to the bus is a user input module 212, which may comprise a pointing device such as a mouse or touchpad, and a display 214, such as an LCD or LED or OLED display panel. The display 214 and input module 212 can be integrated into a single device, such as a touchscreen, as indicated by dashed box 216. Programs such as communication or collaboration applications stored memory 204 for example can be executed by the CPU, and can cause an object to be rendered and output on the display 214. A user can interact with a displayed object, providing an input or inputs to module 212, which may be in the form of clicking or hovering over an object with a mouse for example, or tapping or swiping or otherwise interacting with the control device using a finger or fingers on a touchscreen. Such inputs can be recognized and processed by the CPU, to provide actions or outputs in response. Visual feedback may also be provided to the user, by updating an object or objects provided on the display 214, responsive to the user input(s). Optionally a camera 218 and a microphone 220 are also connected to the bus, for providing audio and video or still image data, typically of the user of the terminal.

User terminals such as that described with reference to FIG. 2 may be adapted to send audio and/or visual data, over a network such as that illustrated in FIG. 1 using a variety of communications protocols/codecs, optionally in substantially real time. For example, audio may be streamed over a network using Real-time Transport Protocol, RTP (RFC 1889), which is an example of an end to end protocol for streaming media. Control data associated with media data may be formatted using Real time Transport Control Protocol, RTCP (RFC 3550). Sessions between different apparatuses and/or user terminals may be set up using a protocol such as Session Initiation Protocol, SIP.

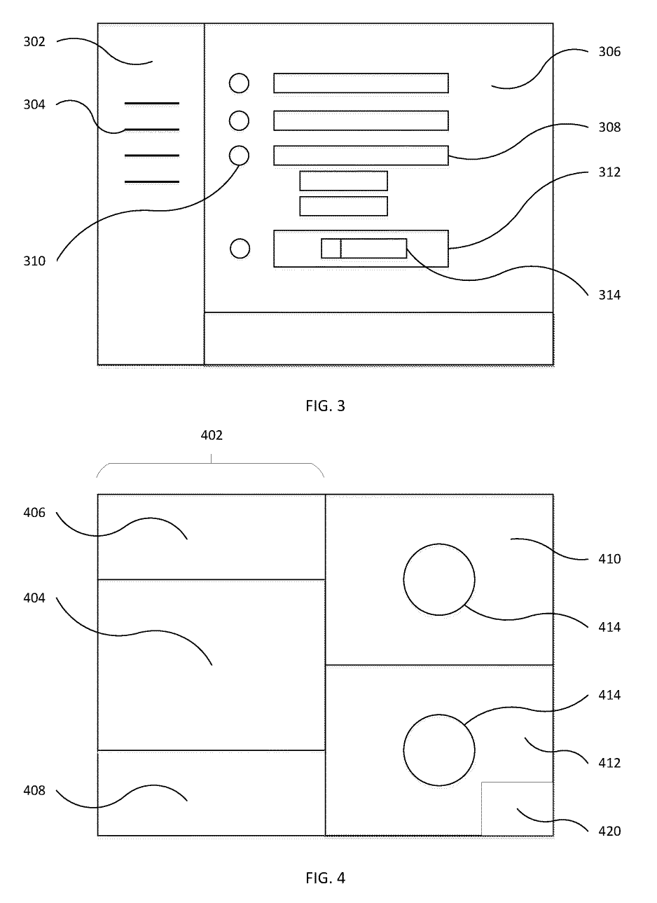

A display as illustrated in FIG. 3 can be provided to a user as part of a communication application, providing a communication environment or visualisation. A user having a unique ID may have a number of contacts within a communication application environment, and may for example belong to a number of groups. A group or groups can define a channel comprising a number of members or groups of members sharing content. The display as illustrated in FIG. 3 can be provided to members of such a channel. Such a display is typically suited to a user terminal such as a laptop or desktop computer, or possibly a tablet device.

A side bar or area 302 can be used to provide information of other users of the tool with whom it is possible to communicate or collaborate. Users can be displayed individually, and/or groups of users and/or channels can be displayed, as illustrated by lines 304, and a user can select between them.

A main area 306 shows messages and chat threads occurring within a selected channel. A message or post 308 contains text content, and an object or icon 310 shows an identifier of a user making the post, which icon can be a picture or avatar or other graphic device. A post 312 contains an embedded link 314, representing a file such as a document for example.

Users of such a communication and collaboration tool are able to engage in shared user events, such as an audio or video call for example. Such a user event is typically defined by one or more participants, with data being shared between participants, typically in real time. Typically, a list of participants, which may be a list of user IDs (possibly also in combination with a device address or an IP address) is defined, and such a list is used to control transmission of data representing the content of the event between participants. Participants of an event may comprise individual users, each accessing the event via separate devices. Participants may also be multiple users grouped at a terminal or device. Data, or at least certain data being shared between participants is typically group cast to all participants simultaneously.

A shared user event may be instigated by specifying one or more users as participants. A shared user event is typically initiated by and administrator or organizer who invites one or more other users to participate in the event. This may be performed by using commands in the sidebar 302, for example double clicking or tapping a user name or a group name, and providing respective commands or inputs to set parameters for the event.

A shared user event may comprise a voice call, video call, group chat, shared desktop, a presentation, live document collaboration, or a broadcast in embodiments.

A shared user event is typically live, and data provided by participants or participant's terminals, such as text, voice, video, gestures, annotations etc. can be transmitted to the other participants substantially in real time. A shared user event may however be asynchronous. That is, data or content provided by a user may be transmitted to other participants at a later time.

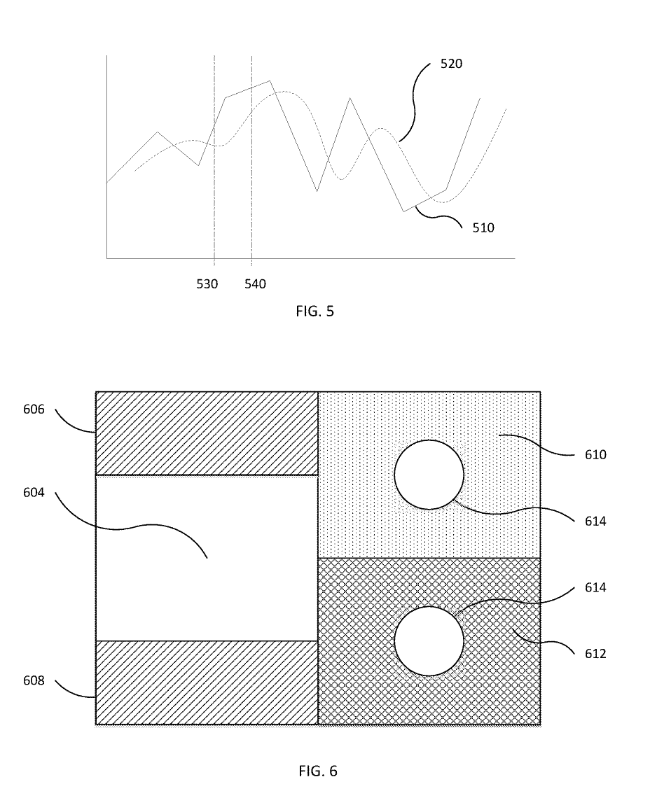

FIG. 4 illustrates a display provided to a participant of a shared user event, in this case a video/audio call.

It can be seen that a display or screen is divided up into different areas or grid sections, each grid section representing a participant of the call. Here the grid is shown with rectangular cells which are adjacent, but the grid cells may be other shapes such as hexagonal or circular for example, and need not be regular or adjacent or contiguous. On the left hand side of the screen, area 402 is assigned to a participant, and a video stream provided by that user is displayed in area 404 It can be seen that area 404 does not fill the whole grid section 402. In order to preserve its aspect ratio, the video is maximised for width, and background portions 406 and 408 exist above and below the video.

The right hand side of the display is dived into two further rectangular grid sections. Each of these grid sections includes an identifier 414 to identify the participant or participants attributed to or represented by that grid section. The identifier may be a photo, avatar, graphic or other identifier, surrounded by a background area 410 for the upper right grid section as viewed, comprising substantially the rest of grid section. In this case, the grid sections on the right hand side represent voice call participants, and these participants each provide an audio stream to the shared event.

A self-view 420 is optionally provided in the lower right corner of the display to allow a user to view an image or video of themselves which is being, or is to be sent to other users, potentially as part of a shared even such as a video call. The self-view 420 sits on top of part of the background 412 of the lower right hand grid section.

FIG. 5 is a graph illustrating a measure of the activity of a participant over time. As will be explained below, the activity can be measured based on a number of factors, or combinations of factors, but an arbitrary activity metric is plotted on the vertical axis with time plotted on the horizontal axis.

Solid line 510 represents instantaneous activity, and may for example be composed of a series of discrete time data. Dashed line 520 is a moving or rolling average of data 510. The moving average value at a given point in time 540 is the average of the N preceding discrete data values, extending back to time 530. Thus the period between times 530 and 540 (or equivalently the number N of values for evenly distributed data) defines a time window, which is shifted forwards, defining a new average as new data points fall within the window, and old data points fall outside of the window.

It will be understood that a value of activity for the moving average 520 at any time has a delay effect, taking into account previous values of instantaneous activity over a time window. The moving average has the effect of smoothing out short term fluctuations, and highlighting longer term trends or patterns. Such a moving average can therefore be considered as a convolution of data, or a low pass filtering effect. The length of such a window can be set depending on the desired degree of smoothing or filtering.

The moving average may be a simple moving average or a weighted moving average, whereby different weights are given to different positions in the sample window. In one example weights are decreased linearly back in time, to increase the importance of the most recent data, but other weightings can be applied, for example weights can be decayed exponentially moving back in time.

The activity metric can be based on or be representative of any type of detectable activity or input of the participant, which it is desired to represent. For example, the activity or input can be detected by a camera such as camera 218 or a microphone such as microphone 220 of the user terminal of FIG. 2. Input can also be detected from a user input device such as input device 212 of the user terminal of FIG. 2, which may be a keyboard or touchscreen for example.

One type of activity is audio or voice activity, and different aspects of voice activity which can be used in obtaining a metric include volume, duration, signal level change, or duration of signal change.

Another type of activity is movement detected by a camera at a user terminal. In this way physical movement of a user or users can be detected, but in reality a movement detection algorithm applied to pixel based image signals could detect any movement in the frame of the camera.

A further type of activity is text input of other input from a device such as a keyboard or mouse or other pointing device. Such input may be input of symbols or icons such as an emoticon symbol, or movement of a pointer on a screen. The input may be in relation to content shared as part of a document shared in the communication event, such as a presentation.

The state of a participant in relation to the communication event may also be used as a type of activity on which an activity metric can be based. A state of joining or leaving said communication event can be taken into account for example, and other states such as a muted state may also be used.

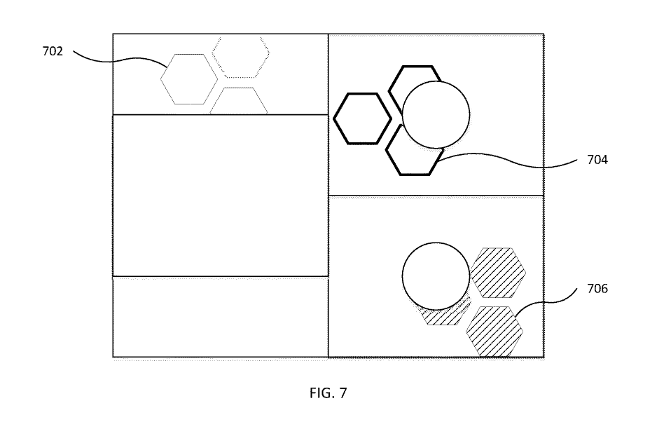

FIG. 6 shows the display of FIG. 4, but with background areas being rendered to provide a visual indication of the activity of the participant or participants associated with the corresponding grid section.

The grid section constituting the left hand side of the display has a background area made up of areas 506 and 508, and these are displayed as having a certain colour or tone indicated by diagonal hatching. The background 510 of the grid section in the upper right hand quadrant is shown as having a colour or tone indicated by dot shading, and the background 512 of the grid section in the lower right hand quadrant is shown as having a colour or tone indicated by cross hatching.

The colour or tone of each of the three described background sections, in this example, correspond to the same colour or hue, but have a lightness or shade which depends on the level of activity which they represent. Therefore, if blue is selected as a base “theme”, backgrounds of different grid sections may be displayed with different shades of blue—light blue, dark blue, mid blue etc. The lightness or shade corresponds to the level of activity of the participant or participants associated with the corresponding grid section. A lighter shade is used to indicate greater activity and a darker shade to represent lesser activity in this example.

The level of activity which determines the shade is preferably a moving average of instantaneous participant activity, as described with respect to FIG. 5 above.

FIG. 7 shows the display of FIG. 4, but with background areas including a pattern to provide a visual indication of the activity of the participant or participants associated with the corresponding grid section.

A pattern or “theme” of hexagons is provided as an example. A group of three hexagons as indicated at 702, 704 and 706 is provided in the backgrounds of the three respective grid sections. Again the background is used to provide a visual indication of the activity of the participant or participants associated with the respective grid section.

A variation of the theme is used to signify the level of participant activity. Variation can be provided in a number of ways, for example the visual weight of the hexagons could be increased, as shown by thicker lines of hexagons 704. Alternatively, the colour or lightness of the hexagons could be varied, as signified by shading of hexagons 706.

It is noted that the pattern of three hexagons is not in the same relative position between the grid sections of the right hand side of the display. The hexagons may in fact be moving, and such movement may be used to indicate the level of participant activity in some examples. Generally, it is desired for higher participant activity to be represented by varying the background to draw attention to the relevant grid section, and therefore increased movement typically represents increased activity. Alternatively, the movement is the same or similar for all grid sections, and other features of the (moving) hexagons are varied.

As well as, or as an alternative to a colour or patterns, a theme which can be applied to a grid section background, and varied to represent activity of a participant can include an image, a graphic such as a company logo for example, video or animation. These can be varied in terms of brightness/lightness, movement, intensity or colour for example.

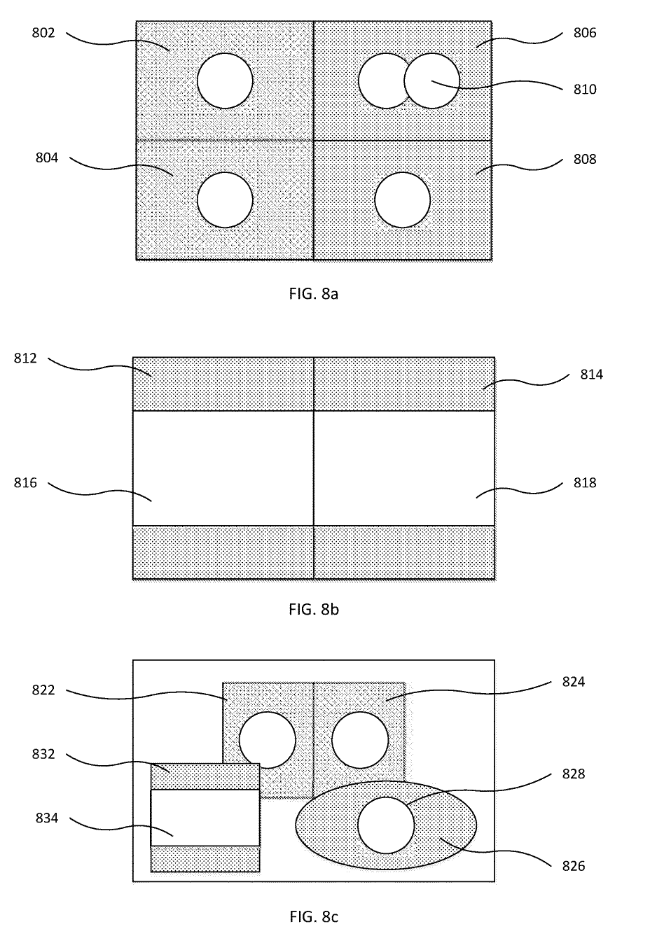

A grid showing three participants has been described with respect to FIGS. 4, 6 and 7, however various other types of grid are possible. FIGS. 8a to 8c show three possible grid patterns, with varying mixtures of audio, video and content participants, and in each case the background portions of respective grid sections, which can be varied to indicate activity, is shown by dotted shading.

In FIG. 8a, four participants are shown in four quadrants 802, 804, 806 and 808 of a regular grid, all four participants providing audio only input. Each grid section includes an identifier (not shaded) to identify a participant or participants. The upper right grid section 806 for example corresponds to two participants, as indicated by overlapping indicators 810. This may be the case where two participants are sharing a microphone.

In FIG. 8b, the display is divided into two grid sections 812 and 814 corresponding to left and right halves. Section 812 on the left half includes a video display area 816 representing a video feed of one participant. Section 814 on the right half includes a document display area 818 representing a shared document such as a presentation being viewed and or worked on by participants. Above and below both display areas 816 and 818 a background area is provided which can be used to indicate the level of activity of the participant represented in the case of grid section 812, and the document represented in the case of grid section 814.

FIG. 8c shows an irregular, non-contiguous grid. Grid sections 822 and 824 are rectangular and share a border. These sections represent two voice participants in a similar manner to the grid sections of FIG. 8a. Grid section 826 is oval in shape, and overlies grid section 824. Grid section 826 includes an identifier 828 and has a background area shown dotted shaded. Grid section 832 is substantially square and partially overlies grid section 824. It includes a display area 834 for a video participant, with background areas above and below display area 834.

In the example of FIG. 8c, the grid sections are “floating” and do not occupy the full extent of the display. Unoccupied display areas can be used for other purposes if desired.

The dotted shaded background areas in FIGS. 8a, 8b, and 8c can be varied in any of the ways described in relation to FIGS. 6 and 7, for example by colours, patterns, movements etc.

Content of a shared user event may also be viewed by non-participants of that event in embodiments. A portal object can be provided and displayed which provides a view of the contents and/or participants of a shared user event. In this way, a user is advantageously able to observe or experience the shared event to at least a limited degree, even though he or she is not a participant of that event. This may inform a user and provide information to allow him or her to make a decision, for example whether he or she wishes to join the event to become a participant.

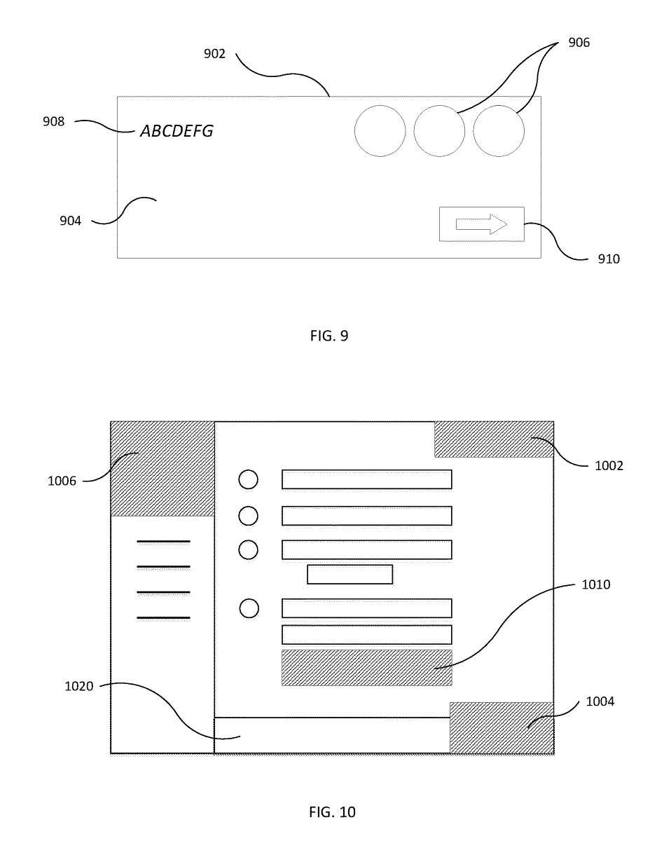

An example of a portal object is shown in FIG. 9.

The portal object 902 has a background area 904 on which can be superposed details including icons or objects 906 that represent and identify participants of the event. If too many participants are present, only a limited number can be displayed, and the number of further participants can be indicated in a single icon. For example, “+3” in a circle would indicate three further participants to those already indicated.

Text 908 can be used to indicate the name of the organizer or administrator of the event, and one or more activation objects 910 can be provided together with the portal object to allow a user to provide an input to perform a specific task relating to the event which the portal represents. For example, an activation object can be provided to allow a user to provide an input to become a participant of the event, or initiate processing to become a participant of the event. Advantageously, such an activation object can allow a user to become an event participant with a single input such as a click or tap.

Background area 904 can be used to provide an indication or visualisation of the content of the event to which the portal object relates. In the example where the shared event is a video call, content may for example include multiple video and audio streams corresponding to multiple different participants. Background area 904 may therefore display one or more of such video streams. The background area 904, or in fact any area of the portal object can additionally or alternatively be used to provide a visual indication of activity of the event to which the portal object relates.

The portal object typically only occupies a small area of a display, allowing the remainder of the display to function as usual, such as in FIGS. 3 and 4 for example. The portal object may be provided in a number of configurations or positions as shown in FIG. 6.

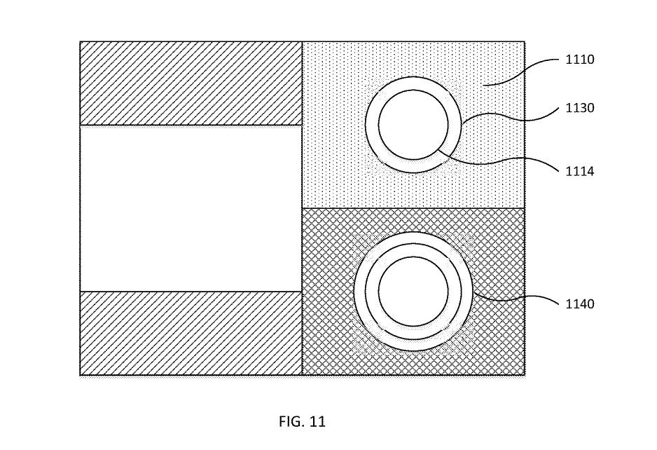

FIG. 10 shows a display for monitoring a channel, similar to that shown in FIG. 3 for example. A first position for a portal object is in a corner of the display such as the top right 1002 or bottom right 1004 of the display. In this position the portal object is rendered in front of other display objects which might otherwise be viewed. For example, portal object 1004 is rendered on top of a menu bar 1020.

The portal object may be ‘docked’ in a dedicated position or display area in the underlying display so than no other display information is occluded. For example, the top portion of a side bar as indicated at 1006 may be used to display the portal object. A further option in a display of a channel where a number of posts are provided, is for the portal object to be displayed in the manner of a post as indicated at 1010.

The portal object can be displayed over or as part of a variety of possible display screens, which may, but need not, belong to a communication or collaboration application. In one example, the portal object is displayed in a calendar, preferably at the corresponding time and or date. The portal object can be scaled and configured to fit the underlying display in which it appears.

The portal object may also be scaled in accordance with the device on which it is to be displayed. For example, a portal object may be reduced in size and reconfigured to fit on a screen of a smartphone or tablet for example.

As noted above, a background area or other area of the portal object can be used to provide a visual indication of activity of the event to which the portal object relates, in a manner analogous to that described above in relation to grid sections representing users in a communication event.

The activity metric can be based on or be representative of any type of detectable activity or input of a participant or participants of the shared user event to which the portal object relates, such as the activity or input detected by a camera such as camera 218 or a microphone such as microphone 220, or an input device such as input device 212 of the user terminal of FIG. 2. Because a single portal object will typically represent an event having multiple participants, said activity metric can be representative of the combined inputs of multiple participants to a shared event. However, it can be arranged to have the desired metric relate to only one, or only to selected participants in some examples.

Possible activity metrics are substantially the same as those described above, and include for example audio or voice activity, movement of a user or users, text input of other input from a device such as a keyboard or mouse or other pointing device.

The state of a participant in relation to the shared user event may also be used as a type of activity on which an activity metric can be based. A state of joining or leaving said communication event can be taken into account for example, and other states such as a muted state, or an active editing state may also be used.

The background area 904, or in fact any area of the portal object can be associated with a visual theme, and this theme can be varied dynamically to provide an indication of the activity of the shared event. The theme, and the variation of such a theme can be substantially as described above. Therefore, a simple colour or hue can be defined as the theme, and the lightness or shade varied depending on a measure or metric of activity. A pattern or patterns can be defined as the theme, static or dynamic, and the visual weight or other visual features of the pattern, the colour or lightness of the pattern, or movement of the pattern can be varied to provide a visual indication representative of activity.

As well as, or as an alternative to a colour or patterns, a theme which can be applied to a portal object, and varied to represent activity of a participant can include an image, a graphic such as a company logo for example, video or animation. These can be varied in terms of brightness/lightness, movement, intensity or colour for example.

FIG. 11 shows a display similar to that of FIG. 6, including two grid sections or display areas on the right hand side, representing two participants providing audio inputs. Considering the top right section, as in FIG. 6, an identifier 1114 such as a picture or avatar identifies a participant represented by that display area. Again as in FIG. 6, a background area 1110 is used to provide a visual indication of the activity of the participant or participants, substantially as previously described. In the example of FIG. 11 however, a further indicator of activity 1130 is provided. In this case, the further indicator is in the form of a ring displayed around identifier 1114. The ring can be varied in colour or lightness or brightness for example to indicate activity. In examples, more than one ring can be provided such as shown at 1140, the number of rings increasing and decreasing to represent varying levels of activity.

Identifier 1130 is preferably used to indicate substantially instantaneous activity, such as voice activity, while background 1110 is preferably used to represent activity over a longer temporal period, offering a smoothed indication of longer term activity

In this way, the further identifier 1130 and background 1110 can be used to simultaneously indicate activity of a participant, over two different timescales. An instant activity indicator 1130 allows a participant to quickly see who is speaking at a given instant, but background 1110 offers more context of the flow of a conversation or event, including a degree of historical context.

It will be understood that the present invention has been described above purely by way of example, and modification of detail can be made within the scope of the invention. Each feature disclosed in the description, and (where appropriate) the claims and drawings may be provided independently or in any appropriate combination.

The various illustrative logical blocks, functional blocks, modules and circuits described in connection with the present disclosure—including the processor 202—may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the function or functions described herein, optionally in combination with instructions stored in a memory or storage medium. The described processor 202 may also be implemented as a one or a combination of computing devices, e.g., a combination of a DSP and a microprocessor, or a plurality of microprocessors for example. Conversely, separately described functional blocks or modules may be integrated into a single processor. The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, and a CD-ROM.

1. A communication method comprising:
receiving input from a participant of a communication event;
causing a display to render at least one grid section associated with at least one participant of a communication event, said grid section including at least one identifier of said participant, and a background area;
associating a visual theme with said background area of said grid section;
obtaining an activity metric of said at least one participant in a communication event based on received inputs of said participant, said activity metric having a range of variability; and
causing the display to vary said visual theme dynamically in dependence upon the activity metric, to provide a visual indication of the activity of said participant.

2. A communication method comprising:
receiving information of a shared user event having one or more participants;
causing a display to render at least one event object representing said shared event, said event object having a foreground relating to the content and/or participants of the shared experience, and a background;
associating a visual theme with the background of said object;
obtaining an activity metric of said one or more participants of said shared event, said activity metric having a range of variability;
causing the display to vary said visual theme dynamically in dependence upon the activity metric, to provide a visual indication of the activity of said shared event.

3. A method according to claim 1 or claim 2, wherein said activity metric is representative of activity over a period of time.

4. A method according to claim 1 or claim 2, wherein said activity metric is a moving average of instantaneous activity values.

5. A method according to claim 1, wherein said activity metric is representative of the audio input of said at least one participant of said communication event.

6. A method according to any one of claim 1, wherein said activity metric is representative of the physical movement of said at least one participant of said communication event.

7. A method according to any one of claim 1, wherein said activity metric is representative of text or symbol input of said at least one participant of said communication event.

8. A method according to claim 2, wherein said activity metric is representative of the combined inputs of said one or more participants to said shared event.

9. A method according to claim 2, wherein said activity metric is representative of the audio input of said one or more participants to said shared event.

10. A method according to claim 2, wherein said activity metric is representative of the physical movement of said one or more participants of said shared event.

11. A method according to claim 2, wherein said activity metric is representative of text or symbol input of said one or more participants of said shared event.

12. A method according to claim 1 or claim 2, wherein said visual theme is a colour, and varying said visual theme includes varying the lightness or shade of said colour in dependence upon the activity metric.

13. A method according to claim 1 or claim 2, wherein said visual theme is a pattern, and varying said visual theme includes varying one or more of the visual weight or other visual configuration of the pattern, the colour or lightness of the pattern, or movement of the pattern.

14. A non-transitory computer readable medium comprising computer readable instructions which when run on a computer cause that computer to perform a method comprising:
receiving input from a participant of a communication event;
causing a display to render at least one identifier of a participant of a communication event;
obtaining an activity metric of said at least one participant in a communication event based on received inputs of said participant; and
causing the display to render first and second visual indicators of activity based on said activity metric, said first and second visual indicators being associated with the respective identifier of the participant, and providing a visual representation of the activity of said participant over first and second different timescales respectively.

15. A non-transitory computer readable medium according to claim 14, wherein said first visual indicator is a substantially instantaneous representation of activity.

16. A non-transitory computer readable medium according to claim 14, wherein said second visual indicator is a representation of activity over a period of time.
